(19) United States
(12) Patent Application Publication
(10) Pub. No.: US 2005/0177337 A1
(43) Pub. Date: Aug. 11, 2005

(54) Vehicle usage forecast

(75) Inventors: Glenn M. Beyer, Mohnton, PA (US); Etienne Richards, Reading, PA (US)

Correspondence Address: BROWN, RAYSMAN, MILLSTEIN, FELDER & STEINER LLP, 900 THIRD AVENUE, NEW YORK, NY, 10022, US

(73) Assignee: Penske Truck Leasing Co., L.P., Reading, PA (US)

(21) Appl. No.: 10/772,601

(22) Filed: Feb. 5, 2004

(51) Int. Cl. G01B 5/02

(52) U.S. Cl. 702/158

(57) ABSTRACT

Method, system, and computer program for automatically analyzing vehicle usage, forecasting anticipated mileage or other usages to be made of vehicles, and for generating mileage forecasts, entries, invoices, contracts, and other documents related to the vehicle usage. The analyst is enabled to monitor, verify, and modify data and analyses to ensure good-quality usage forecasts.

### FIELD OF THE INVENTION

The invention generally relates to the automated analysis of vehicle usage. In particular, the invention relates to the use of computer systems in the forecasting of future vehicle usage and in the automated generation of invoices, contracts, reports, and other documents using forecast usage estimates.

### BACKGROUND OF THE INVENTION

The prediction of the future usage to which vehicles and other machinery are to be put is useful in many circumstances. For example, the automotive rental and leasing industries use various types of billing arrangements with their customers. Under some such arrangements, customers are billed for the use of vehicles based on anticipated future usage of the vehicles. One way of estimating future usages of vehicles for such billing arrangements has been to base forecasts for vehicle usage on past usage of the vehicles.

### SUMMARY OF THE INVENTION

The invention provides improved systems and methods for mathematical analysis of vehicle usage. For example, in one embodiment, the invention uses statistical techniques for making and verifying the quality of vehicle mileage and other usage forecasts.

The invention is useful, for example, in preparing usage forecasts and generating invoices, contracts, reports, and other documents for use in the operation, maintenance, leasing, charter, sale, design and other aspects of the use and study of vehicles, including automobiles, aircraft, watercraft, trains, and other vehicles. The invention is also applicable to the use and study of other machinery, such as generators and other motor- or engine-driven devices.

For purposes of this disclosure, the term forecast includes estimates made for usage which may in fact be partially or wholly in the past, but which is more recent than a period for which historical data exists, or is otherwise available or desirable for use, as well as to estimates for usage during wholly future periods. For example, a forecast according to the invention may be made for usage of one or more leased vehicles which occurred during a billing period covering a time period which has partially or wholly elapsed, but for which it is impracticable or otherwise impossible or undesirable to compile or use data pertaining to elapsed portion(s) of the time period.

Among other advantages, the systems and methods of the invention provide improved formulae for the preparation of vehicle forecasts, and improved processes for verifying the quality of and otherwise processing the data upon which forecasts are based, and for assessing the quality of estimates made. All aspects of the cost, efficiency, and speed of forecasting vehicle usage are improved.

In one embodiment, the invention provides a method, performed by a computer, for forecasting a future usage of a vehicle during a designated period of time using historical usage data. In this embodiment, the method comprises the computer mathematically determining a usage forecast for a vehicle during a time period designated by a user of the computer, using stored data representing historical usage information for the vehicle, and storing the forecast usage in permanent or temporary memory. The forecast usage can include a predicted distance (e.g., a number of miles or kilometers) a vehicle will be driven, or a predicted number of cycles or hours of operation an engine will be subjected to, during a specified period of time.

In one embodiment, the invention provides a method, performed by a computer, for estimating a distance a vehicle will be driven during a designated period of time. The method comprises the computer verifying that stored data representing historical mileage information for a vehicle is accurate; mathematically determining a forecast of mileage the vehicle will be driven during a designated time period, using the stored historical information; assessing a probable error associated with the mileage forecast; and storing the forecast usage in permanent or temporary memory.

It is noted that mileage may be expressed in any units of distance, including miles, kilometers, and/or other units of measure. As will be appreciated by those of ordinary skill in the art, distance measures are easily convertible from one system of measurement to another.

Methods according to the invention may be implemented using any suitable form of stored vehicle usage data. For example, data recorded by vehicle monitors and/or operators including one or more past, or historical, odometer and/or other meter readings, and times and/or dates of recordation, stored in an electronic storage medium in a format suitable for use in electronic data processing, may be used. Prior billing statements or billing data, including paper copies thereof, are another example of data that may be used. Such data may be based upon mileage driven or other usage made historically of one or more particular vehicles for which a usage forecast is to be determined, by one or more similar vehicles, such as one or more vehicles belonging to a same class or fleet of vehicles, or upon any other data determined to be suitable for the purposes to which the forecast is to be put.

The method may be implemented using any suitable statistical methods or techniques, or other algorithms for forecasting vehicle usage and/or for assessing data quality. Statistical techniques that have been found to be suitable for use with the invention include, for example, linear and non-linear regressions. For example, the use of non-linear regression may be preferable where vehicle usage fluctuates considerably over a period of time; for example, where vehicle usage varies seasonally, as might be the case in passenger car rentals, particularly for recreational purposes, recreational sailboat or snowmobile leases. In addition, any suitable statistics, such as R² and Cook's Distance, both of which are well known to those skilled in the relevant arts, may be used to assess the quality of historical data and forecasts.

In some embodiments, the quality of data available for use in forecasting vehicle usage is assessed prior to the determination of the forecast usage. Assessment of data quality may be useful, for example, in assessing the quality of forecasts made using the data. Assessment of data quality may also be used to improve the quality of data used in making forecasts. For example, where stored data representing past, or historical, usage of a vehicle is used, the data may be automatically reviewed by programs implemented by the forecasting computer system, and data which is of a nature which has been determined to be potentially less reliable than other data is not used, e.g., the data is deleted or otherwise removed from consideration in the analysis. The assessment and scrubbing of data is particularly useful where, for example, data is of insufficient, inconsistent, or otherwise suspect quality, as for example where mileage data is incorrectly read from an odometer or incorrectly recorded, or where stored data has been corrupted. For example, odometer readings for a motor vehicle must be at least as great as previously recorded values.

In one embodiment of the invention forecasts of vehicle usages made in accordance with the disclosure herein may also be assessed for accuracy, so that the forecast are verified. For example, a probable error in the forecast, in view of the accuracy of input data, statistical techniques used, etc., may be assessed, and the probable error provided to one or more outputs, optionally as designated by a system user. Users of the system may be provided the opportunity to review data and analysis quality, and to massage or otherwise modify or review data and/or analyses.

Time periods for which vehicle mileage and other usage parameters are forecast, or otherwise estimated, by a computer system may be designated by the computer system, by a user of the computer system, or by any combination thereof. For example, a user may specify a time period, or a time period may be provided by default, optionally overrideable, by the computer system. The time period may be designated as a date range, as a period of any duration of interest, e.g., a day, week, month, quarter, year, etc., or in any other suitable manner.

In one embodiment of the invention, mileage or other usage forecasts provided according to the invention are provided to outputs designated by a user. Designated outputs may include storage and/or other output devices. For example, a mileage or other usage forecast may be provided to an output file for storage and/or use in further processing, as for example in preparing an invoice, report, or contract. Data, documents, data files or structures, and other products of processing using the usage forecasts may also be provided to outputs, such as storage media, printers, e-mail, or any wireline or wireless communications devices such as facsimiles or pagers, in accordance with designations of system users. Such embodiments enable the automatic preparation and forwarding, for example, of hard copies or electronic invoices, lease contracts, or other documents. Where forecasts are provided to data files, the files may be accessible via one or more networks, so that, for example, a user may access the files remotely, via the Internet, a LAN, etc., using secured or unsecured protocols.

The inputting and processing of data to provide the forecasts disclosed herein may be accomplished in any suitable manner. A wide variety of such processes are already known and well understood, including, for example, batch and interactive input processes, electronic file transfers, and the like. The selection and implementation of suitable input and processing processes will be well within the ability of those skilled in the art of creating and operating such systems, once they have been made familiar with this disclosure. In some embodiments of the invention at least some data and some control commands for performing the processes disclosed herein are input interactively from local or remote user stations, using, for example, computer screens, interactive graphical user interfaces, keyboards, computer mice and other pointing devices, and other input/output devices. The invention is readily adaptable, for example, for implementation via the Internet and other computer communications networks.

In one embodiment, the invention provides a method, performed with the aid of a computer, for determining a vehicle rental price. The method comprises the determining a mileage estimate for a vehicle, using stored data representing historical mileage information, and determining a rental price for the vehicle using the mileage estimate.

In another embodiment, the invention provides a method, performed with the aid of a computer, of preparing an invoice for a rented vehicle. The method comprises determining a mileage estimate for a vehicle, using stored data representing historical mileage information, determining an invoice price using the mileage estimate, and storing the invoice price in permanent or temporary storage.

In some circumstances it is advantageous for this or other embodiments of the invention to provide the invoice price, or other information determined as a part of or using the usage estimate, formatted in a human-readable form, to facilitate, for example, the preparation of invoices, contracts, or other documents or data structures.

In other aspects the invention provides computer-readable medium or media comprising machine-executable programming logic for causing a computer system to perform the methods described above; and computer systems for performing such methods.

Among other advantages, the invention enables the control of the quality of analyses through the monitoring, verification, and control of the both the types and quality of input data used.

Additional aspects of the present invention will be apparent in view of the description which follows.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 is a schematic diagram of a computer system suitable for use in implementing the invention.

FIG. 2 is a schematic diagram of a process of making a vehicle usage forecast according to the invention.

FIG. 3 is a schematic diagram of a process of inputting historical usage data suitable for use in implementing the process of FIG. 2.

FIG. 4 is a schematic diagram of a process of verifying historical usage data suitable for use in implementing the process of FIG. 2.

FIG. 5 is a schematic diagram of a process of forecasting future vehicle usage suitable for use in implementing the process of FIG. 2.

FIG. 6 is a schematic diagram of an estimation method suitable for use in implementing the process of FIG. 2.

FIG. 7 is a schematic diagram of a process of saving future vehicle sage forecasts suitable for use in implementing the process of FIG. 2.

FIGS. 8A-8B are schematic diagrams of processes suitable for use in implementing the invention.

FIGS. 9A-9D are tables illustrating an example of an iterative linear weight filter process according to the process of FIG. 4.

FIGS. 10A-10C are graphs illustrating forecast analysis processes according to the invention.

### DETAILED DESCRIPTION OF THE PREFERRED EMBODIMENTS

Preferred embodiments of methods, systems, and apparatus according to the invention are described through reference to the Figures.

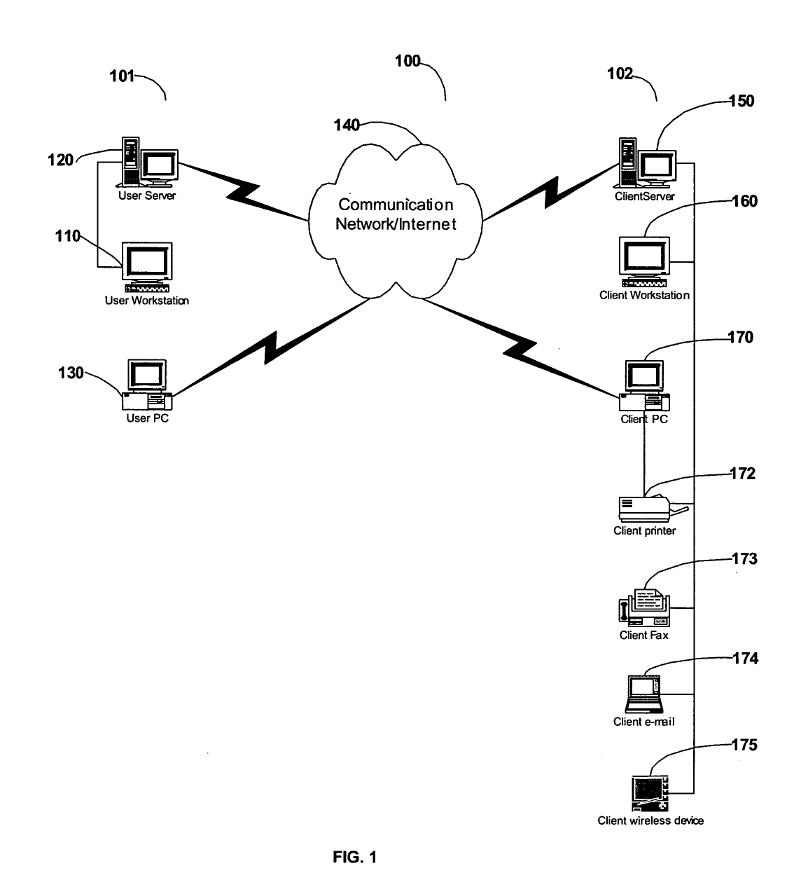

Referring to FIG. 1, an example of a computer system 100 suitable for use in making vehicle usage estimates and otherwise processing data according to the invention includes one or more analysis systems 101 and optionally one or more remote user systems 102 connected by communications network 140. Analysis and user systems 101, 102 comprise any processors, memories, and/or input/output devices necessary or useful for making forecasts and communicating and otherwise processing data as described herein. As will be appreciated by those skilled in the relevant arts, once they have been made familiar with this disclosure, a wide variety of suitable systems are already known, from stand-alone PCs or workstations to large, complex networks, and doubtless many will be hereafter developed.

As will be further understood by those skilled in the relevant arts once they have been made familiar with this disclosure, implementing the invention using architectures such as that shown in FIG. 1 enables concentrated and/or distributed analysis, storage, processing, control and use of forecasts by one or several users, whether the users are locally- or remotely located with respect to one another, including the inputting of data and the review and/or modification of input and completed forecasts. Any numbers of analysis- and/or user-stations may be linked using communications networks such as local- or wide-area networks, public networks such as the Internet, etc., and optionally alternative communications systems such as wireless telephones and wired or wireless facsimile systems. Analysis and/or other data processing functions may be concentrated in one analysis system or distributed among many, with input/output functions being distributed in any suitable or convenient manner.

In the embodiment shown in FIG. 1, analysis system 100 comprises an analysis workstation 110 connected to a server 120; a stand-alone system 130, and remote customer systems 102 including a server 150, workstation 160, PC 170, printer 172, facsimile 173, e-mail system or station 174, and/or customer wireless device.

Among the advantages offered by the architecture depicted in FIG. 1 is the enablement of distributed data entry and data processing. For example, a user of a remote user system 102 is enabled to enter or otherwise provide data for use in an analysis performed by an analysis system 101, or optionally to request or control an analysis, or to receive raw or processed output results from the analysis system 101. Such users may also review and/or modify data and/or analyses according to their needs or desires. For example, any one or more of analysis workstation 110, analysis PC 130, customer workstation 160 and customer PC 170 may be used for inputting historical usage data, and for controlling, completing, reviewing and modifying mileage forecasts. System 100 may comprise a database or a memory device for storing the historical usage data and mileage forecasts; suitable memory devices include, for example, microchips, optical, tape or disk-based memory, etc.

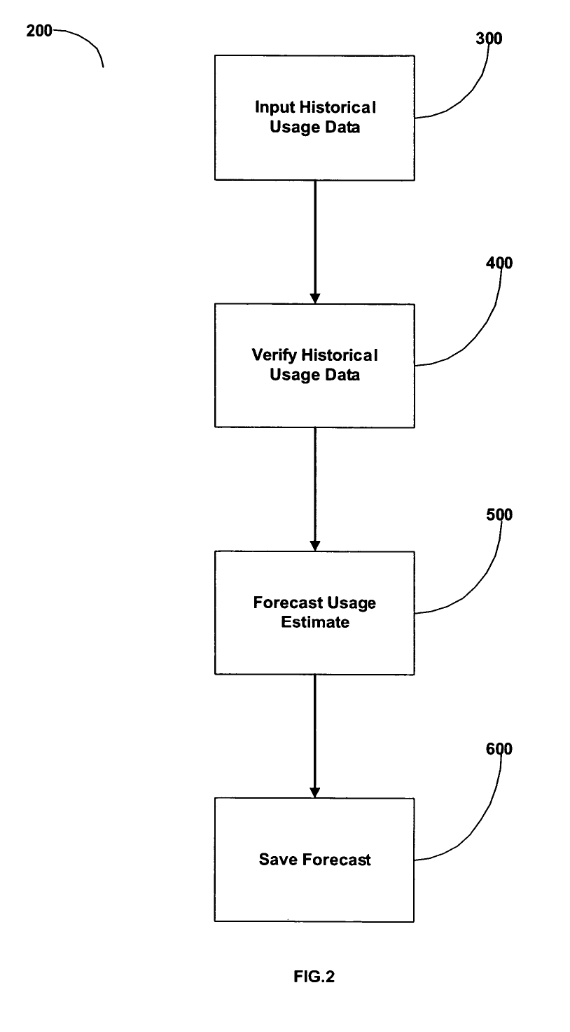

FIG. 2 is a schematic diagram of an example of process 200 suitable for forecasting vehicle usage according to the invention. Process 200 comprises accessing historical usage data at 300, verifying at 400 that accessed historical usage data is suitable for use in forecast analysis, forecasting future usage of the vehicle(s) at 500, and saving the forecast usage(s) at 600.

Any or each of the process steps shown in FIG. 2 may be accomplished in any manner consistent with the objects herein, and in any suitable order. For example, historical data accessed at 300 may be provided locally at the analysis system 101, or may be input or otherwise provided by a user of a remote system 102; and forecast or other analyses may be conducted by or on behalf of users of analysis systems 101 and/or remote user systems 102. Accessed data may be captured, provided or otherwise made available in any suitable manner, as for example by local or remote keystroke input working from data provided in paper, electronic, or other documents, by automatic data acquisition using processes or devices such as bar code readers, electronic gauges, or other automated data collection systems; or in any other suitable manner. A great many ways of accomplishing the individual steps or parts of the processes disclosed herein will occur to those skilled in the relevant arts, when they have been made familiar with this disclosure.

Processes according to the invention may include all of the process steps shown in FIGS. 2-8, or any subsets of those steps, as described herein.

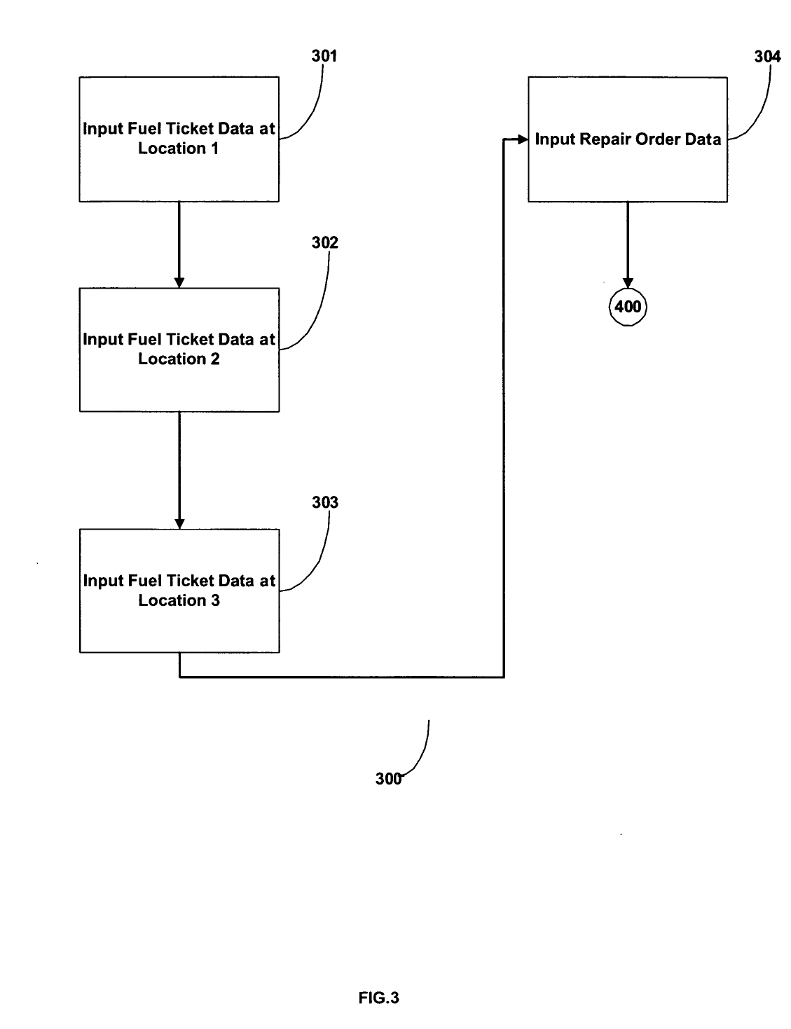

FIG. 3 shows a schematic diagram of an example of process 300 suitable for providing historical usage data accessed in implementing process 200 shown in FIG. 2. Historical usage data is entered manually, automatically, or in any combination thereof, or in any other suitable fashion. For example, in the case of a system for providing future usage forecasts such as mileage forecasts for leased or rented vehicles, data may be entered manually by one or more users of keyboards at analysis station(s) 110,120, or 130, or by a lessee or other user of a remote user system 102, working from documents such as fuel tickets or prior rental or leasing invoices showing an odometer or engine-hour readings at a time at which fuel was dispensed to a given vehicle or a payment became due, or an amount of fuel consumed by a vehicle during a given time period, or dispensed into a vehicle or vehicles at a given time or over a period of time; or the data may be may be directly acquired by and downloaded into a computer memory from a vehicle's odometer, fuel gauge, or other device, including for example a tracking system such as a system using a global positioning system or other positioning device, through wireline or wireless communication links; or through the use of other automated or semi-automated data acquisition processes. Optionally, after being entered or downloaded, historical data may be retrievably stored in a memory device or a database of system 100 which may be accessible online to both analysis system(s) 101 and customer system(s) 102. Historical data may be entered specifically for performing a usage forecast or may be entered for shared use with other administrative tasks, for example, vehicle maintenance analysis.

In the embodiment shown in FIG. 3, which is suitable, for example, for providing mileage or other usage forecasts for use in preparing leases, rental agreements, maintenance schedules, or in other aspects of using or maintaining vehicles, one or more users of, for example, one or more analysis stations 101 and/or remote user stations 102 input at 301, 302, 303 included in or otherwise associated with fuel tickets, or other records indicating amounts of odometer or other vehicle-usage data such as engine operating hours and/or amounts of fuel consumed. As will be understood by those familiar with the relevant arts, fuel consumption data may be used, as for example in conjunction with known vehicle gas consumption/mileage data, in determining historical vehicle usage data, such as mileage driven, hours of engine operation, numbers of engine power cycles, etc. At 304, one or more users provide input derived from vehicle repair or maintenance document(s). Such documents may provide, for example, odometer readings or other indicators of vehicle usage.

As process 300 proceeds through steps 301-304, analysis system(s) 101 can cause all input data relevant to the current forecast to be collected, and can perform any formatting or other processes necessary or desirable for facilitating the analysis, such as for example writing collected data a common data file or database, or otherwise preparing individually-entered records for processing in connection with relevant analyses.

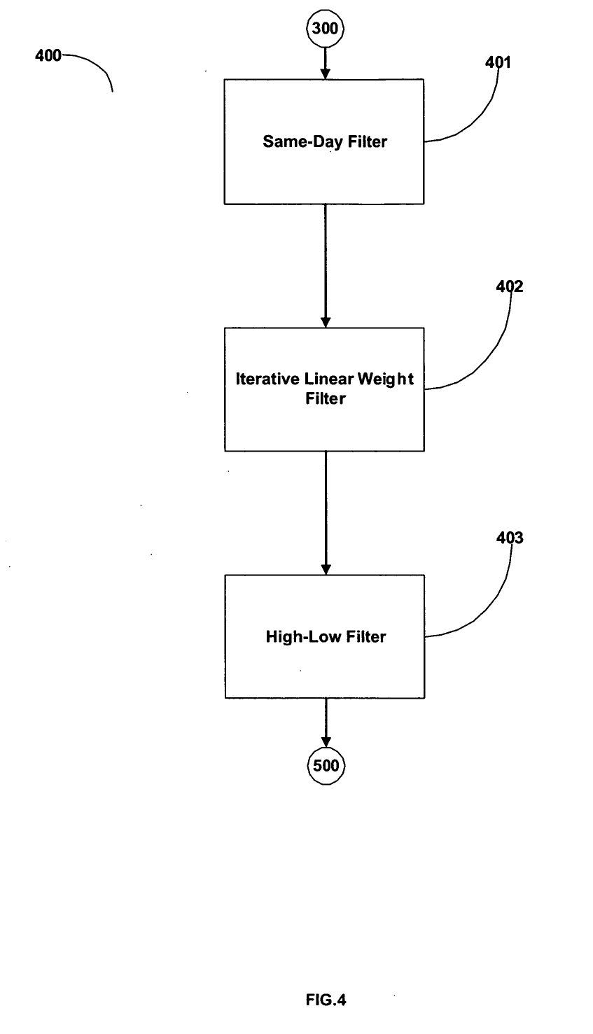

Preferably, as the input data is collected and collated, or at any other convenient or otherwise advantageous point during processing, the validity of input data is assessed. Verification of data can provide advantages such as the assurance or improvement of the quality of forecasts and other usage analyses. FIG. 4 shows a schematic diagram of an example of process 400 suitable for verifying historical usage data in implementing process 200 of FIG. 2 by using a variety of filters involving comparison of individual data records to be used in the forecast analysis to other data records to be used. In general, process 400 of FIG. 2, if performed, may be implemented using any or all of the illustrated techniques, and/or any other suitable verification technique(s). If data is not verified, then following data collection or access at 300, processing may proceed to the forecast analysis at 500. The example process 400 of FIG. 4 is particularly well suited for use in conjunction with usage forecasts using regression or other statistical analyses.

In the embodiment of process 400 shown in FIG. 4, a same-day filter verifying process 401, an iterative linear weight filter verifying process 402, and a high-low filter verifying process 403 are applied sequentially, so that data sets to be used in given analyses are subjected to each filter process in turn. In various embodiments these and/or other filters may be employed sequentially or in parallel, separately or in any combination.

Same-day filter process 401 is used to review sets of data records to identify data records associated with a common date, and to retain for analysis purposes only those data records associated with the most recent data. For example, in an embodiment of the invention in which data derived from odometer or other gauge readings are used, such as a fuel-ticket odometer readings or a number of engine operating hours read from an engine clock, data comprising a date and time of day on which the reading was made, and the type, make, model, and/or individual vehicle from which the reading was made, may be included within or otherwise associated with each data record; and when two or more records associated with a common date are provided for an analysis, only the data associated with the most recent time of day is considered in making the analysis.

Iterative linear weight filter process 402 can also be used to verify the consistency of data records in relation to other data records, so that those data records which are most consistent with each other may be retained for analysis. In one such process, useful for example in analyses based on input comprising dates and/or times and odometer or other gauge readings, the relative consistency of each data record is scored against all other data records. Each data record is scored once, after which the data set is filtered, with all data records having the highest scores being retained for analysis.

In one embodiment of such a process 402, a linear weight is calculated for each data record within a data set, and used to filter the data. Each data record is compared against all other records in the data set. If a date/time associated with the record is more recent than that of the record it is compared to and the associated gauge value (e.g., odometer reading) is larger, a weight value associated with the record is incremented. If the data point is older than the record against which it is compared, and its associated gauge value is lower, the associated weight value is incremented. If neither condition is met, the associated weight value is not incremented. If, following comparison of all records to all other records, all records are associated with the same weight value, or with an otherwise-acceptable distribution of weight values, all records are retained for analysis and the filtering/verification process is considered complete. If all records are not associated with the same weight value, one or more points associated with lower weight values are eliminated and the process is repeated until a satisfactory weight distribution or weight-value uniformity is achieved.

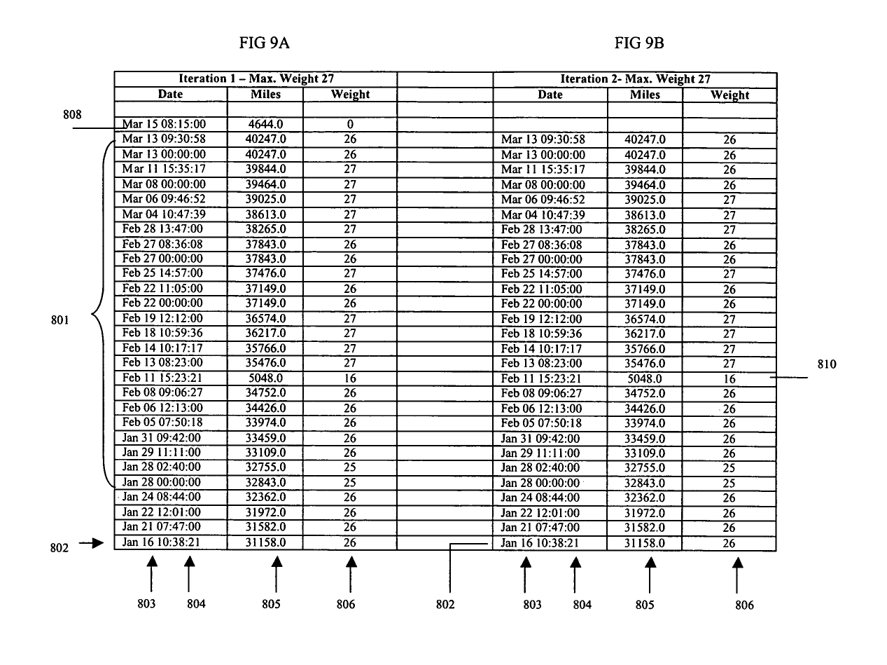

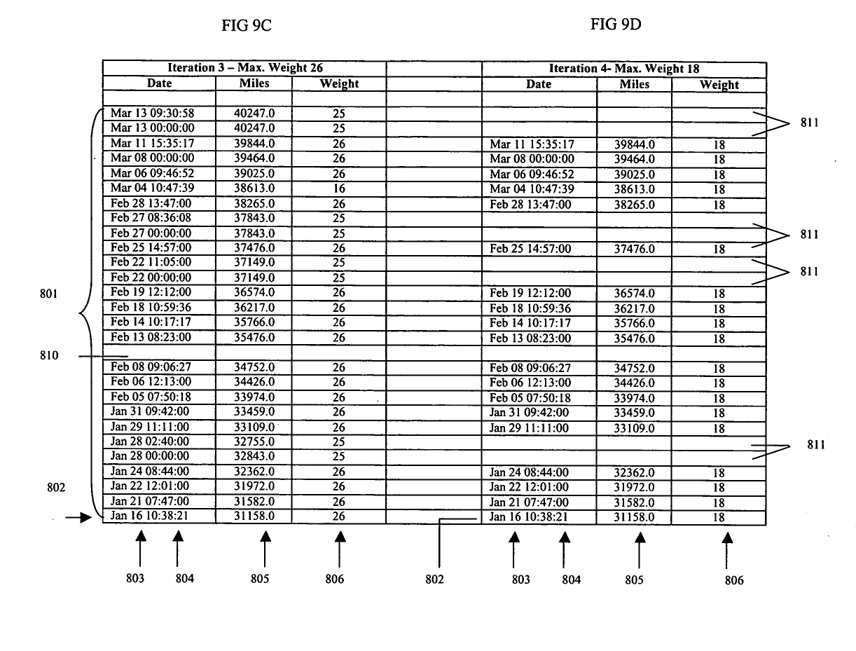

FIGS. 9A-9D illustrate an example of an iterative process 402 in operation. After four iterations, 10 out of 29 of the least reliable data records are eliminated; all data records have been associated with equal weights and are considered equally valid.

In the first iteration, as illustrated in FIG. 9A, data set 801 of 29 data records 802 is shown. Each data record 802 comprises an associated date 803; time of day 804; and gauge reading 805, here an odometer reading indicated in miles. Each record 802 has been compared with every other record 802, as described above, and an associated weight has been determined by incrementing weight value 806 by a value of one for each comparison in which the described criteria are met. As a result of the comparison the associated weights 806 shown have been assigned. The record with the lowest score, namely record 808, is eliminated, as for example by deletion from the data file or other memory containing the data set 801, and the process is repeated.

Following a second iteration, as shown in FIG. 9B, the indicated weight values 806 have been associated with each of the remaining records 803 in data set 802. As a result, a further record 810 is eliminated.

Following a third iteration, as shown in FIG. 9C, a further eight records 811 are eliminated, resulting in reduction of data set 801 to the 19 records shown in FIG. 9D. As each of the associated weight values 806 of FIG. 9D is the same, the filter iteration process is stopped, and the analysis or further filtering proceeds.

Another example of a process for verifying that data representing historical vehicle usage data is accurate by comparing historical data records to each other is high-low filter process 403, which can be used to ensure that a most recent data record is associated with a greatest gauge reading within an identified data set, and that an oldest data record is associated with a lowest gauge reading, and to eliminate the oldest and/or most recent records if they do not meet such a criteria.

One advantage of verification processes 400 such as those described here is that the possibility that verified data sets used for analysis are affected by factors other than the actual data points for a specific vehicle is minimized; and it is ensured that all data used are consistent with each other.

An additional filter, which is useful where, for example, it is desired to reduce the impact of seasonal or other time-related variations, is to use only data records generated or input within a given date range or time period. For example, in embodiments used for the generation of vehicle lease contracts in which it is desired to reduce the effect of seasonal usage variations, only data for the last 120, 90, 60, or 30 days, or other designated time period, may be used.

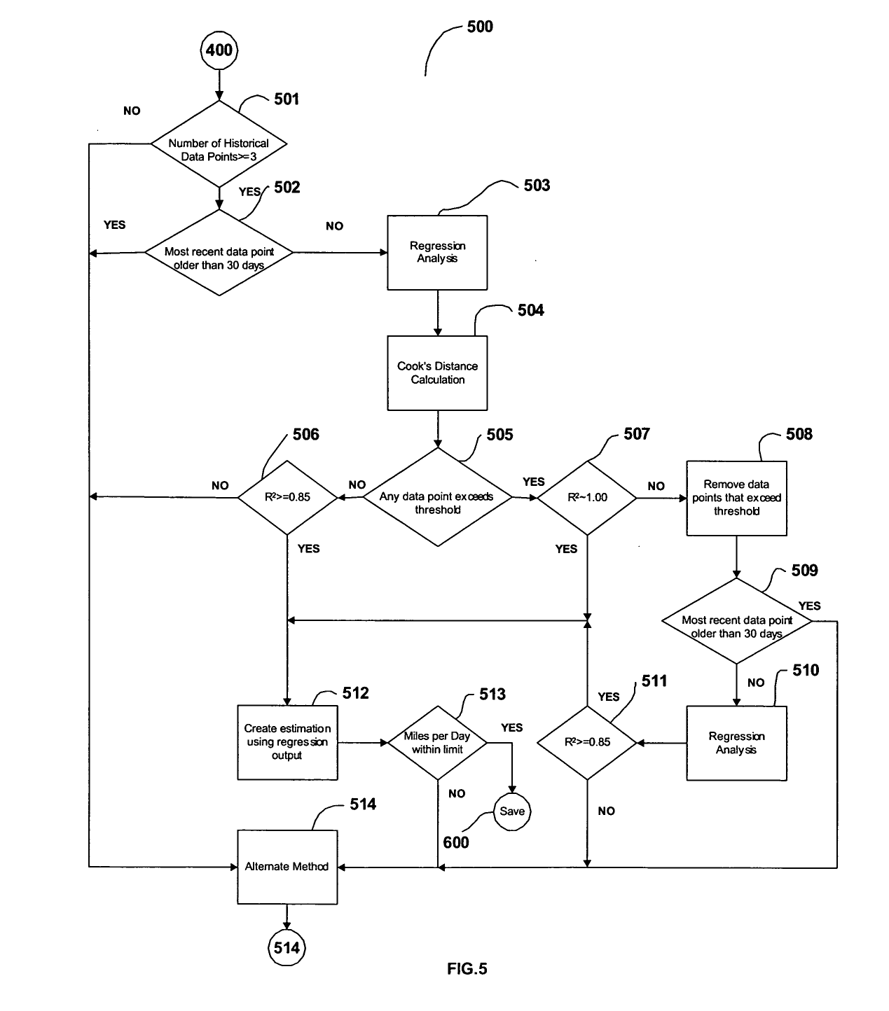

FIG. 5 shows a schematic diagram of a process 500 of forecasting future vehicle usage suitable for use in implementing the invention. Process 500 is useful, for example, in forecasting future vehicle usage for the generation of vehicle rental or leasing contracts. In the embodiment shown, process 500 further facilitates review and filtering of input to control and improve the quality of usage forecasts.

Process 500 of FIG. 5 begins at 501 with verification that a minimum number, e.g., three, of (optionally prescreened and verified) data records are available for analysis. As will be appreciated by those skilled in the relevant arts, the consideration of a minimum number of data points in making an analysis may be used to help assure that a resultant analysis is of an acceptable or otherwise desired quality. As will be further appreciated by those skilled in the relevant arts, an acceptable or otherwise desirable minimum number of data points for use in a given analysis will depend upon the type of analysis performed, the formulae or algorithms used in making the analysis, and the accuracy desired or required in the results. If a desired minimum number of data points (e.g., three data records) are not available, an alternative method 514, such as a hand analysis or other contract-based method (e.g., a standard-form or flat-rate contract) may be used.

At 502, it is determined whether the most recent historical data point is older than a defined threshold, for example, 120, 90, 60, or 30 days. If the relevant data is older than the defined threshold, an alternative method 514 may be used.

If the data is not older than the threshold, at 503 a regression or other suitable analysis is applied to the data. As is well understood by those skilled in the relevant arts, a regression analysis is a statistical technique used to establish a relationship between dependent (e.g., mileage or other vehicle usage) and independent (e.g. time, elapsed time, or time ranges) variables, e.g. to fit theoretic curves to observed data points. Once an equation describing a suitable curve of vehicle usage vs. elapsed time in a designated future time period (e.g., a week, month, or year) has been determined, using input historical usage data, a forecast of anticipated usage during that time period may be made and used for further analysis, billing, leasing, or other purposes. Regression analyses are well understood in the mathematical and other arts. See, e.g., JOHN NETER ET. AL., APPLIED STATISTICS (3d ed. 1988).

In one embodiment of the invention, forecasts are made using linear regression techniques to determine formulae for predicting future vehicle usage based on past usage of vehicles. As will be appreciated by those skilled in the pertinent arts, a wide variety of non-linear regression and other statistical techniques may also be used.

In a linear regression analysis for forecasting future vehicle usage in accordance with the invention, a formula of the form Y=a+bX is used, where Y is a future odometer, clock, or other instrument or gauge reading, X is a future date or time period designated by a user for purposes of the analysis, and a and b are constants determined using historical input usage data using the formula:

$$a = \frac{\sum {Y}_{i}}{n} - b \frac{\sum {X}_{i}}{n} ; b = \frac{\sum {X}_{i} {Y}_{i} - ( \frac{\sum {X}_{i}}{n} ) \sum Y}{\sum {X}_{i}^{2} - {n ( \frac{\sum {X}_{i}}{n} )}^{2}}$$

where Xᵢ is the date/time datum 803, 804 associated with the i^{th} individual data record 802, Yᵢ is the odometer or other usage datum 805 associated the i^{th} data record, and n is the number of data records 802 used in the analysis.

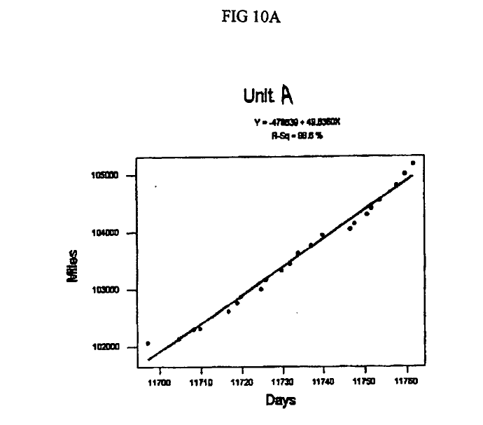

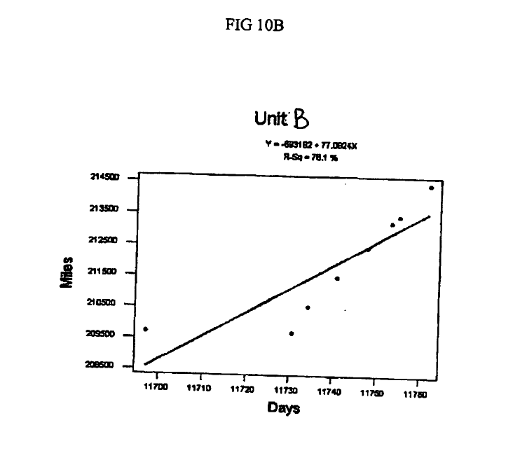

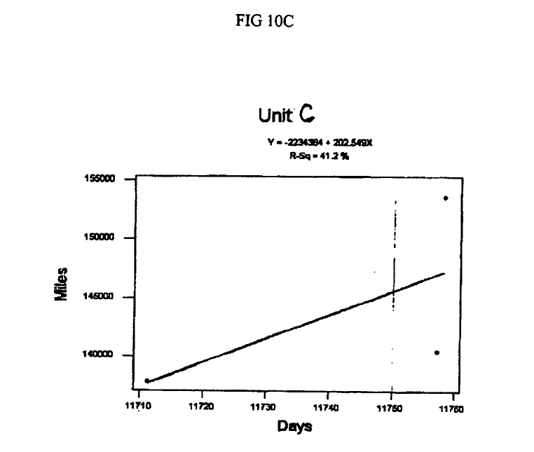

FIGS. 10a-10c show individual data points (Xᵢ and Yᵢ) used to perform a linear regression analyses plotted with curves of the form Y=a+bX determined using the data. In FIG. 10a, 22 data records have been used, so that for the illustrated case n=22; in FIG. 10b, n=8; and in FIG. 10c, n=3.

At 504, a process of assessing an anticipated quality of the forecast enabled using the curve determined at step 503 is begun. One process for assessing the anticipated quality of the forecast is the use of Cook's Distance. Cook's Distance, which is a measure of the effect of a particular data point, i.e., any particular data record 802 of data set 801, on a regression analysis made on the basis of a data set 801 which includes the data point represented by the data record 802, by considering how far the data point is from the means of the independent variables and the dependent variable. If the data point is far from the means of the independent variables, it may be very influential and one can consider whether the data point should be dropped from the data set used in the analysis, and the analysis repeated with the reduced data set.

At 504, the value of Cook's distance for each data point used in the analysis is determined. Cook's Distance may be determined using the following equation:
COOKDᵢ=(1/p)(hᵢ/1−hᵢ)(standardized residualᵢ)²,
where p is the number of parameters used in the analysis and hᵢ is the i^{th} diagonal of the hat matrix:
hᵢ=xᵢ(X′X)⁻¹xᵢ′
If H is the hat matrix, then for the X-space matrix of the data set 801,
H=X(X′X)⁻¹X′.

A residual is an observed-minus a fitted-covariance. A standardized residual is a residual divided by an estimated standard error. As is understood by those familiar with the relevant arts, such residuals exist for every pair of observed variables. Fitted residuals depend on the unit of measurement of the observed variables. If the variances of the variables vary considerably from one variable to another, it may be difficult to determine whether a fitted residual should be considered large or small. Standardized residuals, on the other hand, are independent of the units of measurement of the variables. In particular, standardized residuals provide a “statistical” metric for judging the size of a residual.

A large positive residual indicates that the analytic model underestimates the covariance between the two variables. On the other hand, a large negative residual indicates that the model overestimates the covariance between the variables. In the first case, the model may be modified by adding paths which could account for the covariance between the two variables better. In the second case, the model may be modified by eliminating paths that are associated with the particular covariance.

At 505, the Cook's distance value of each data point represented by a data record 802 is compared to a predetermined threshold value. For example, a data point i may be dropped if the Cook's Distance for that point exceeds a designated threshold level, so that
COOKDᵢ>F(0.5,p,n−p),
where F is the F distribution, p=number of parameters, n=number of data points or data records used in the analysis.

If the Cook's distance value for any data point 802 does not exceed the designated threshold, then at 506 a least-squares method is used to determine whether an acceptably reliable equation has been determined for making the usage forecast, using the parameter R² determined for the data set 801:

$${R}^{2} = 1 - ( \frac{\sum {( {Y}_{i} - {\hat{Y}}_{i} )}^{2}}{\sum {( {Y}_{i} - \overline{Y} )}^{2}} ) , where {\hat{Y}}_{i} = a + {bX}_{i} and \overline{Y} = \frac{\sum {Y}_{i}}{n}$$

If R² for the data set 801 is determined at 506 to be less than 0.85 (or any other value determined to be suitable, in view of the nature and goals of the analysis), then an alternate forecasting method may be considered at 514. If the Cook's distance value for any data point 802 does not exceed the designated threshold and R² is greater than or equal to 0.85 for the data set 801, then at 512 an estimated vehicle usage is determined using the forecast equation determined at 503 and at 513 a check is made whether the forecast vehicle usage for the designated time period is within a designated, e.g. proposed contractual, limit. If the forecast usage is within the designated limit, at 600 the estimate is saved, for example, for use in preparing an invoice, lease, or other document. If the forecast usage is outside the designated limit, an alternative analysis method may be considered at 514, with subsequent processing as appropriate.

If the Cook's distance value for any data point 802 does exceed the designated threshold and it is determined at 507 that R² is approximately 1.00 (that is, R² is within a designated tolerance approximately equal to 1.00; the determination of suitable tolerances will be well within the ability of those skilled in the relevant arts, once they have been made familiar with this disclosure, in view of the objectives of the analysis and the nature of the formulae and data used), then at 512 an estimated vehicle usage is determined using the forecast equation determined at 503 and at 513 a check is made whether the forecast vehicle usage for the designated time period is within a designated, e.g. proposed contractual, limit. If the forecast usage is within the designated limit, at 600 the estimate is saved, for example, for use in preparing an invoice, lease, or other document. If the forecast usage is outside the designated limit, an alternative analysis method may be considered at 514, with subsequent processing as appropriate.

If at 507 it is determined that R² is not acceptably close to 1.00, then at 508 any data records 502 for which the Cook's Distance value exceeds the designated threshold are removed from the data set 801 considered in the analysis and at 509 the determination is made whether the most recent data point in data record 802 in the reduced data set 801 is older than a designated threshold, for example, 120, 90, 60, or 30 days. If the relevant data is older than the designated threshold, an alternative method 514 may be used. If the date threshold is not exceeded at 509, then at 510 the regression analysis is repeated, using the same or another method, and the R² for the reduced data set 801 is determined. If the R² value is less than 0.85, an alternate method of analysis may be considered at 514. If the value of R² is greater than or equal to 0.85 (or other designated value), the process of creating the usage forecast at 512 is repeated.

By assessing and controlling the quality of input data records 802, the quality of the forecast analysis may be controlled. For example, FIGS. 10b and 10c illustrate situations in which R² statistic is substantially lower than the 0.986 of the graph depicted in FIG. 10a, meaning that the accuracy of the forecast based on these two regressions may be lower.

In another embodiment of the invention, the following regression formula may be used: Y=a+bX+ε, where the residual ε is a random variable with zero mean. A regression analysis may further comprise calculating the standard residual ε for each data point and eliminating the data points whose residual values exceed a user-defined threshold. In some conditions, as will be appreciated by those skilled in the relevant arts, the accuracy of the forecast can thereby be increased.

Among the advantages offered by the invention is control of the quality of the analysis and of the resulting usage forecast, by for example filtering data prior to use, by assessing the influence of individual data points on the forecast, and by determining the overall quality of the fit of the estimated relationship to the data records 802 used to make the estimate.

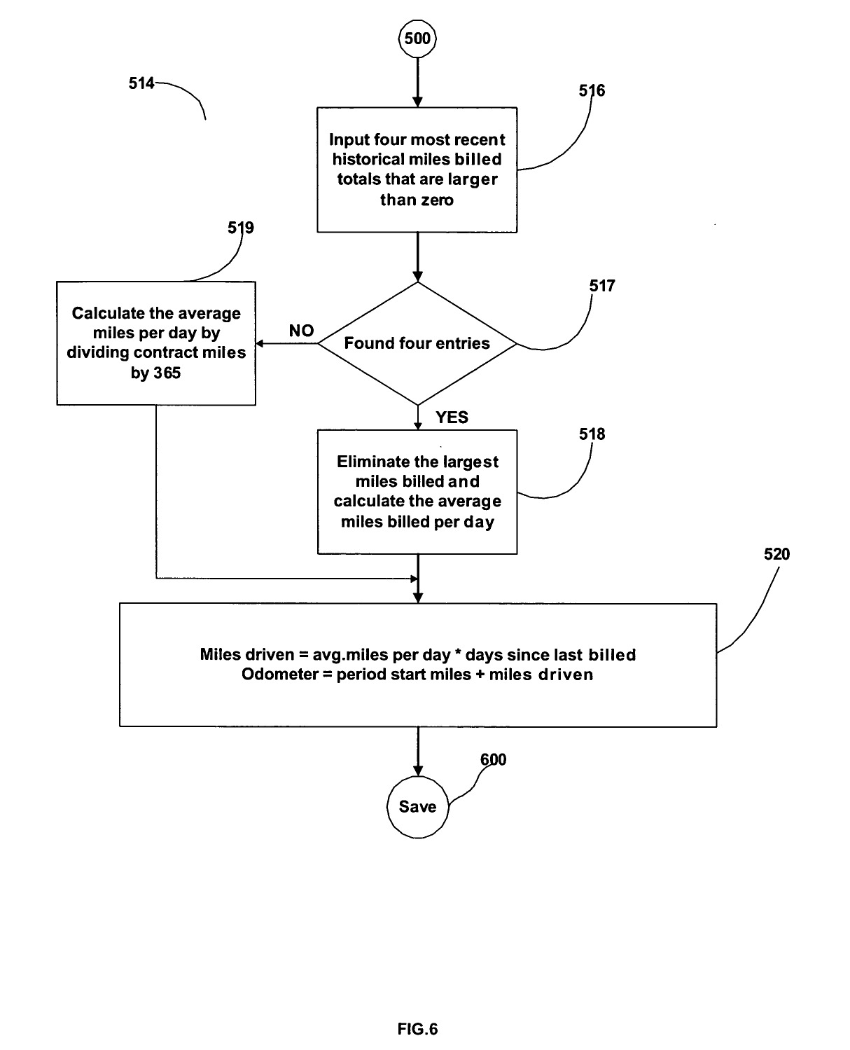

FIG. 6 shows a schematic diagram of an example of an alternative process suitable for use at step 514 of FIG. 5. Process 514 begins at 516 with inputting four most-recent historical mileage data points larger than zero for the vehicle for which mileage is being forecast. If four such data points are determined at 517 to be available for the analysis, the largest data point is eliminated at 518 and the average miles per day are calculated; otherwise, the average miles per day may be calculated by dividing an annual contractually-defined miles by 365 at 519. At 520, the estimated miles driven or other estimated usage made of the vehicle is calculated by multiplying the average number of miles per day calculated at 518 or at 519 by the number of days to be included in the designated period to be covered by the forecast and adding the result to the last reported historical mileage or other usage indicator, with the resultant estimate (e.g., forecast odometer reading) to be used as desired in billing, contract preparation, maintenance plans, etc.

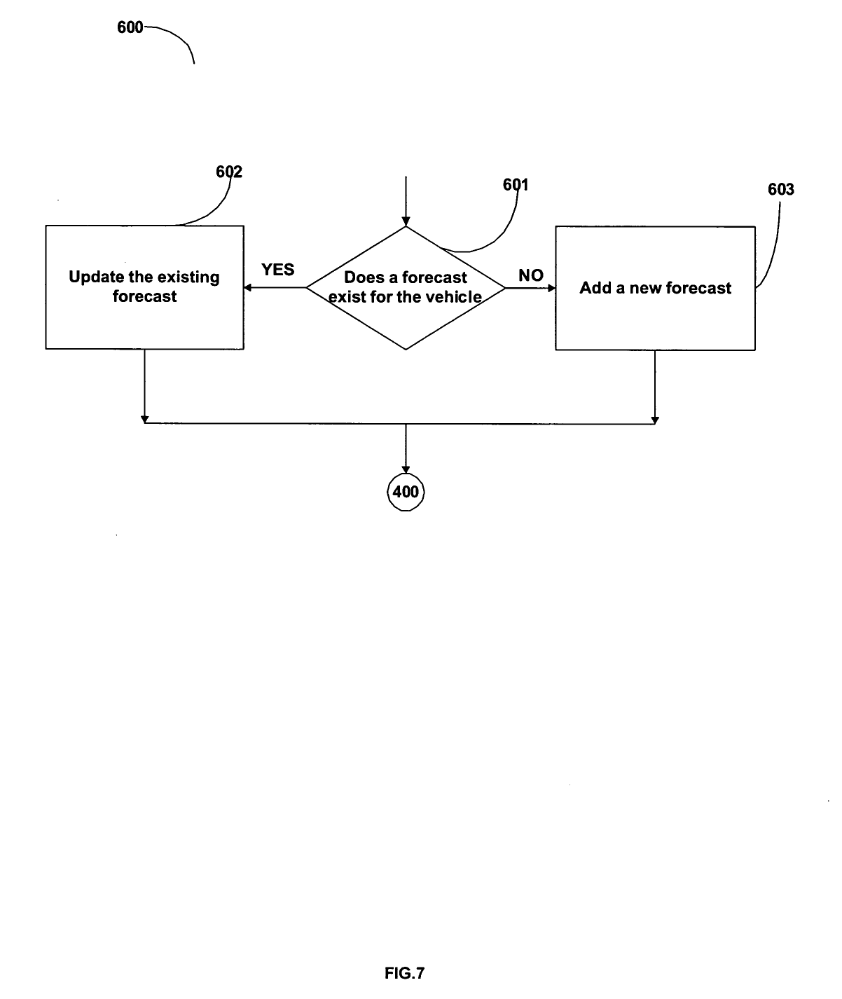

FIG. 7 shows a schematic diagram of a process 600 of saving a vehicle usage forecast in accordance with the invention. Process 600 begins at 601 with checking whether a forecast already exists for the vehicle(s) for which usage is being forecast. If a prior forecast does exist, at 602 the existing forecast is updated and saved; otherwise, a new forecast is generated and saved at 603. At 900 any subsequent processing, such as the preparation of invoices, contracts, or maintenance schedules, is initiated.

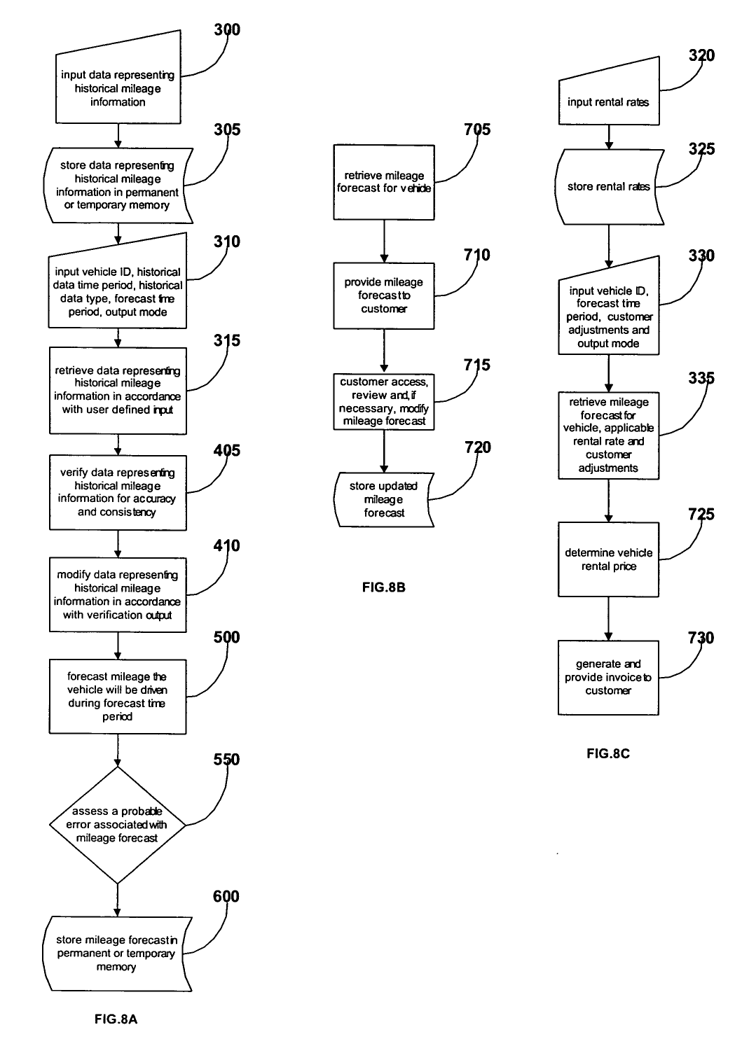

FIGS. 8a-8c show schematic diagrams of example processes suitable for use in making and using mileage forecasts to generate rental invoices according to the invention. At 300 a locally- or remotely-located user inputs data representing historical mileage data for a particular vehicle. The same process may be implemented using data relating to a class of vehicles, or vehicles bearing other relations to each other.

At 305, the historical usage information is stored in permanent or temporary memory or a database which may be accessible online, or which is otherwise accessible via network. By making data available to users at remote locations, it is possible to facilitate entry and modification of data, and initiation, completion, and modification of forecasts by the remote users.

At 310, the same or another user inputs an ID for a vehicle (a unit #) whose future mileage will be estimated, historical dates and/or time periods associated with the input data, the time period(s) for which the forecast is desired, and output mode. For example, a historical data time period may limit the historical data used to estimate the future mileage to the most recent 60 days with older data being ignored. A user may enter Period Ending, which is a date to which the odometer reading is to be forecast; Data Start Date-all data points must have been entered on or after this date; Data End Date-all data points must have been entered on or before this date. For example, for monthly billing arrangement: Period end—25 May 2002, Data Start Date=17 Feb. 2002; Data End Date=17 May 2002. For example, the time period may also be designated by default or may be designated by specifying at least one reference date.

Also, at 310, the user may enter an historical data type, for example, data indicating that the data representing historical mileage information is associated with the vehicle for which the mileage is estimated, or another vehicle or class of vehicles. For example, a class or category of vehicles may comprise vehicles of the same or similar type, functionality, brand, purchase or rental price, age, historical mileage, customer, and/or geographic location as the vehicle for which the mileage is estimated. The user may also specify the time period for which the forecast is desired; an analysis type, including for example formulae to be used in making the analysis and in verifying or filtering input data; and output options. For example, a user can indicate that results are to be further processed to provide a rental invoice, which can be provided by e-mail, automatically- or manually generated facsimile, etc.

At 315, historical mileage information is retrieved in accordance with the user-defined parameters entered at 310.

At 405, the historical mileage data is verified for accuracy and consistency and modified, if necessary, at 410. In one embodiment, verification processes 405 and 410 may correspond to verification process 400 shown in FIG. 2 and FIG. 4.

At 500, which may correspond to a process of forecasting future vehicle usage 500 shown in FIG. 2 and FIG. 5, a future mileage is forecast. At 550, a probable error associated with the mileage forecast is assessed and if found acceptable, the mileage forecast is stored in permanent or temporary memory at 600; otherwise, data may be reviewed, modified, and further filtered, or an alternative forecasting method, for example, method 514 shown in FIG. 6, may be used.

As mentioned, at 310 the user may designate an output mode. For example, the user may specify how the mileage forecast is transmitted to a customer of the vehicle for which the mileage has been estimated. For example, the forecast may be transmitted to the customer automatically via the Internet or any wireline or wireless communication device. In one embodiment of the invention, the stored mileage forecast is retrieved at 705 and provided to the customer at 710 as shown in FIG. 8b.

At 715, the customer may access the forecast, for example, via the Internet, review the forecast and, if necessary, modify it, when the customer believes, for example, that the historical usage has been lower or higher than the anticipated usage of the vehicle and is authorized to modify the data and/or the analysis. The updated forecast is then stored at 720. In addition to a numerical mileage estimate, the customer may be provided with a visual representation of the forecast process, for example, a regression analysis graph showing an R² value, in order to illustrate to the customer how the forecast was obtained and to allow the customer to evaluate the accuracy of the forecast.

Once a forecast has been prepared, it may be used in many ways. For example, it may be used to schedule maintenance for a vehicle or a fleet of vehicles, to prepare a contract for a lease or rental, to prepare an invoice, or to prepare other documents. In FIG. 8c, a process for determining a rental price and generating an invoice for a vehicle is shown.

At 320, the user of the analysis system 101, e.g., a vehicle lessor, inputs a plurality of rental rates and conditions for its vehicle fleet. The rental rates are stored at 325 in permanent or temporary memory such as a database.

At 330, the user inputs a vehicle ID, forecast time period, customer adjustments, if any, and an output mode. For example, the plurality of rental rates adjustments may include a vehicle's type, functionality, brand, price, age, historical mileage, customer promotions, geographic location, and/or seasonal adjustment requirements. As at 310 in FIG. 8a, the output mode allows the user to specify how the rental price and a corresponding invoice is transmitted to the customer. For example, the price may be transmitted to the customer automatically via the Internet or any wireline or wireless communication device.

At 335, the system determines and/or retrieves a mileage forecast for the vehicle, an applicable rental rate and applicable customer adjustments. At 725, the vehicle rental price is determined using the determined distance forecast for the vehicle and a rental rate corresponding to the vehicle from the plurality of rental rates as well as the customer adjustments, if any.

At 730, an invoice is generated and provided to the customer in accordance with the output preferences specified by the user and/or by the customer. For example, the output may include regular or express mail, telephone, facsimile, e-mail, a secure webpage, or a wireless device, such as a pager or a cellular phone. In one embodiment of the invention, the invoice may include in machine-readable and/or human readable form: the time period, the vehicle rental price, the distance forecast, the rental rate, historical mileage, and all the adjustments used to determine the vehicle rental price.

It will be understood by those of ordinary skill in the relevant arts that the various data processing tasks described herein may be implemented in a wide variety of ways, many of which are known and many more of which will doubtless be hereafter developed. For example, a wide variety of computer programs and languages are now known, and will likely be developed, that are suitable for storing, accessing, and processing data, and for performing, processing, and using forecasts and other analyses are disclosed herein. Examples include the various spreadsheets and data processing programs provided by major software manufacturers, suitably modified or adapted in accordance with the disclosure herein.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

1. A method, performed with the aid of a computer, for estimating a distance a vehicle will be driven during a designated period of time, comprising:
verifying that data representing historical mileage information for a vehicle is accurate;
mathematically determining a forecast of mileage the vehicle will be driven during a designated time period, using the data representing historical mileage information;
assessing a probable error associated with the mileage forecast; and
storing the forecast usage in permanent or temporary memory.

2. The method of claim 1, wherein mathematically determining the forecast of mileage the vehicle will be driven comprises a regression analysis.

3. The method of claim 1, wherein the time period is designated by a user.

4. The method of claim 1, wherein the time period is designated at least initially by default.

5. The method of claim 1, wherein the time period is designated by specifying at least one reference date.

6. The method of claim 1, comprising providing the forecast of mileage to an output designated by a user.

7. The method of claim 6, wherein the output includes at least one of facsimile, e-mail, a webpage, a printer, and a wireless device.

8. The method of claim 6, wherein the forecast of mileage is provided to an output automatically.

9. The method of claim 1, wherein verifying that data representing historical mileage information for a vehicle is accurate comprises comparing historical data representing historical mileage information to other data representing historical mileage information.

10. The method of claim 1, wherein verifying that data representing historical mileage information for a vehicle is accurate comprises comparing said data representing historical mileage information to forecast mileage.

11. The method of claim 1, wherein at least one of the verifying that the data representing historical mileage information for a vehicle is accurate, mathematically determining the forecast of mileage, assessing a probable error associated with the mileage forecast, and storing the forecast in permanent or temporary memory is performed by the computer is subject to prior confirmation by a user of the computer.

12. The method of claim 1, wherein at least one of the verifying that the data representing historical mileage information for a vehicle is accurate, mathematically determining the forecast of mileage, assessing a probable error associated with the mileage forecast, and storing the forecast in permanent or temporary memory is performed by the computer using data input to the computer by a user of the computer using an interactive computer interface.

13. The method of claim 1, wherein the permanent or temporary memory includes memory accessible via a network.

14. The method of claim 1 further comprising a customer accessing and modifying the stored mileage forecast.

15. A method, performed with the aid of a computer, for forecasting a future usage of a vehicle during a designated period of time, comprising:
mathematically determining a usage forecast for a vehicle during a time period designated by a user of the computer, using data representing historical usage information for the vehicle;
storing the forecast usage in permanent or temporary memory.

16. The method of claim 15, comprising providing the forecast usage to a device designated by the user.

17. A method, performed by a computer, for estimating a distance a vehicle will be driven during a designated period of time, comprising the computer:
determining a forecast of mileage a vehicle will be driven during a selected time period, using regression analysis and data representing historical mileage information; and
storing the forecast usage in permanent or temporary memory.

18. A method, performed with the aid of a computer, for estimating a distance a vehicle will be driven during a given period of time, comprising:
mathematically determining a mileage forecast for a vehicle, using data representing historical mileage information; and
assessing a probable error associated with the mileage forecast.

19. A method, performed with the aid of a computer, for evaluating an estimate of a distance a vehicle will be driven during a given period of time, comprising:
determining a mileage estimate for a vehicle, using data representing historical mileage information; and
determining a rental price for the vehicle using the mileage estimate.

20. The method of claim 20, wherein the data representing historical mileage information comprises data associated with the same vehicle.

21. The method of claim 20, wherein the data representing historical mileage information comprises data associated with at least one vehicle other than the vehicle for which the mileage is estimated.

22. A method, performed with the aid of a computer, for evaluating an estimate of a distance a vehicle will be driven during a given period of time, comprising:
determining a mileage estimate for a vehicle, using data representing historical mileage information;
determining an invoice price using the mileage estimate; and
storing the invoice price in permanent or temporary storage.

23. The method of claim 22, comprising formatting the invoice in a human-readable and/or machine-readable form.

24. The method of claim 22, comprising providing the invoice to an output designated by a user.

25. The method of claim 24, wherein the output includes at least one of a facsimile, an e-mail, a memory accessible via a network, and a printer.

26. The method of claim 24, wherein the invoice is provided to the output automatically.

27. Computer-readable medium or media comprising machine-executable programming logic for causing a computer system to perform the methods of claims 1, 15, 17, 18, 19, or 22.

28. A computer system comprising a computer-readable medium or media including machine-executable programming logic for causing the computer system to perform the methods of claims 1, 15, 17, 18, 19, or 22.
